(19) United States
(12) Patent Application Publication
(10) Pub. No.: US 2016/0250794 A1
(43) Pub. Date: Sep. 1, 2016

(54) BLOWN FILM EXTRUSION SYSTEM AND PROCESS FOR MANUFACTURING A PLASTIC PRODUCT

(71) Applicant: A P PLASTICS LTD, Toddington, Cheltenham Gloucestershire (GB)

(72) Inventor: Andrew Kevin PARKER, Toddington (GB)

(21) Appl. No.: 15/029,291

(22) PCT Filed: Oct. 14, 2014
(86) PCT No.: PCT/GB2014/053084

§ 371 Date: Apr. 14, 2016

(30) Foreign Application Priority Data
Oct. 15, 2013 (GB) 1318252.2

(51) Int. Cl. B29C 47/88; B29C 55/28; B29C 47/92; B29C 47/00

(52) U.S. Cl. CPC B29C 47/883; B29C 47/0026; B29C 55/28; B29C 47/92; B29C 2947/92104; B29C 2947/92152; B29C 2947/926; B29C 2947/92647; B29C 2947/92971

(57) ABSTRACT

A blown film extrusion system, comprising a circular die (10) for creating a tube of molten plastic which is blown into a bubble (30). A Cooling stack (1) is provided in the center of the circular die (10), within the bubble (30) in use, the Cooling stack (1) including an integrated IBC exhaust stack (24). Air from within the bubble (30) is drawn into an air inlet manifold (180) and spun to a high velocity into a substantially conical air distributor (150). This causes the air to be forced against the surfaces of the copper tubes (92) causing transfer of heat from the air to the tubes. The air is then expelled at the bottom of the Cooling stack (1) back into the bubble (30), where it rises back up to cool the inner surface of the bubble (30), before being drawn back into the air inlet manifold (180) for re-cooling.

This invention relates to a blown film extrusion system and process for the manufacture of plastic films.

In blown film extrusion, a thermoplastic melt provided by an extruder is shaped in a circular die into a molten tube which as it exits the die is then blown with air from the inside and thereby forming a bubble to the desired diameter. At the upper end of the film bubble, the inflated bubble is continuously collapsed flat by suitable guide mechanisms commonly referred to as a “collapsing frame” and drawn off by nip rollers.

The thermoplastic tube that exits the die is stretched in a defined ratio to form a bubble. It is stretched both in the transverse direction and machine direction. This stretching process reduces the thickness of the tube to the required final thickness.

As the film is stretched to its final dimensions, it transitions from molten to solid. This transition can be seen in the bubble and is known as the frost line. The height of the frost line in relation to the die is dependent on the overall cooling rate and influenced by the type of thermoplastic material and its transition temperature, thickness of the film, diameter of bubble and production rate.

Cooling of the molten tube, once it exits the die, is by intensively cooled air. This is done with the aid of an external air ring, which blows cooling air radially onto the tube from the outside.

In blown film plants, additional internal cooling of the bubble is achieved with what is commonly known as Internal Bubble Cooling (IBC). This process works by cooled air being forced into the bubble through the die and the hot air being sucked out of the bubble through the die as an air exchange process. Mounted on the die, there is an IBC plenum which distributes the incoming cool air radially against the inside surface of the bubble and an IBC Exhaust stack that extracts the hot air from high up in the bubble.

In order to maintain the stability of the bubble above the frost line as it is being drawn up the tower by the nip rollers, it passes through a sizing cage.

Sensors are provided, externally of the bubble, to measure the thickness of the film and control the diameter of the bubble, these measurements are used to control the film production process: profile optimization, i.e. film flatness and average thickness. This contributes to material savings and reduces material waste during product changes.

In prior art systems, such profile optimization may, for example, be achieved by a control system which adjusts the temperature of the external cooling air via a heating element mounted inside the external air ring in response to measurements received from the sensors during the extrusion process.

The cooling rate is critical in terms of defining the mechanical properties of the plastic film and it is highly desirable to increase the cooling rate of the plastic, which not only results in an increase in output and productivity, but also improves the mechanical properties of the final product i.e. impact strength. It is an object of the present invention to address these issues, amongst others, and provide an improved blown extrusion system and process, which provides numerous advantages over the prior art.

In accordance with a first aspect of the present invention, there is provided a blown film extrusion system, comprising:
a cooling stack comprised of an integrated IBC exhaust, air inlet manifold, a fan assembly and a substantially cylindrical air distributor for receiving a flow of air from said air inlet manifold, said air distributor having spiral vanes and defining an air flow conduit and direction of said air flow, the cooling stack further comprising a substantially cylindrical heat exchanger for receiving said air flow from said air distributor;
means for blowing and cooling a tube of molten plastic into a bubble around said cooling stack;
   the cooling stack being configured to draw air from within said bubble into said heat exchanger via said air distributor, and means for expelling air from said heat exchanger back into the space defined between said bubble and said cooling stack.

Also in accordance with the first aspect of the present invention, there is provided a cooling Stack adapted to be mounted within a blown film extrusion system comprised of an integrated IBC exhaust stack, an air inlet manifold, and means for blowing and cooling a tube of molten plastic into a bubble around said cooling stack, the cooling stack comprising an integrated IBC Exhaust, an air inlet manifold, a fan assembly, a cylindrical air distributor, with spiral vanes defining an air flow conduit and direction of the air flow and a substantially cylindrical heat exchanger for receiving said air flow from said air distributor, the cooling system being configured to draw air into said heat exchanger via said air distributor, and means for expelling air from said heat exchanger after cooling.

Thus, the cooling system of the present invention can be used to complement existing external air ring and IBC systems; and can be mounted, in use, on top of a modified IBC plenum, in which case, it has the IBC exhaust stack integrated into the invention.

It is highly advantageous to expel the air uniformly back into the space defined between the bubble and the invention. Thus, in a preferred embodiment of the invention, the means for expelling air from the heat exchanger back into the space defined between the bubble and the IBC exhaust stack comprises:
a) a plate carrying a plurality of radial veins defining radial conduits for guiding air from the heat exchanger into said space. Most preferably, the veins are equidistantly spaced substantially all of the way around the circumference of the plate, such that air is uniformly expelled all of the way around the base of the bubble; and/or
b) a cylindrical mesh outer screen, with defined profile, to allow air to be uniformly expelled radially from the voids between cooling coils in the heat exchanger.

In accordance with a second aspect of the present invention, there is provided a blown film extrusion system, comprising:
cooling means comprised of an air inlet, a heat exchanger and an air outlet;
means for blowing a tube of molten plastic into a bubble around said cooling means;
   the cooling means being configured to draw air from within said bubble onto said heat exchanger and to said air outlet, wherein said air outlet is provided with:
a) a plate carrying a plurality of radial veins defining radial conduits for guiding air from the heat exchanger into the space defined between said bubble and said cooling means; and/or
b) a cylindrical mesh outer screen, with defined profile, to allow air to be uniformly expelled radially from the voids between cooling coils in the heat exchanger;
   depending on processing requirements.

Means may be provided for selectively heating or cooling some or all of said veins so as to enable the temperature of air within said radial conduits to be controlled. This is especially useful in arrangements employing automatic film profile control systems.

The heat exchanger may comprise a plurality of concentric tubes so as to form a substantially cylindrical chamber, and the system further comprises one or more for feeding water into said tubes. The concentric tubes may be alternately arranged relative to said one or more pipes so as to alternately reverse water flow direction therethrough.

Embodiments of the present invention will now be described by way of examples only and with reference to the accompanying drawings, in which:

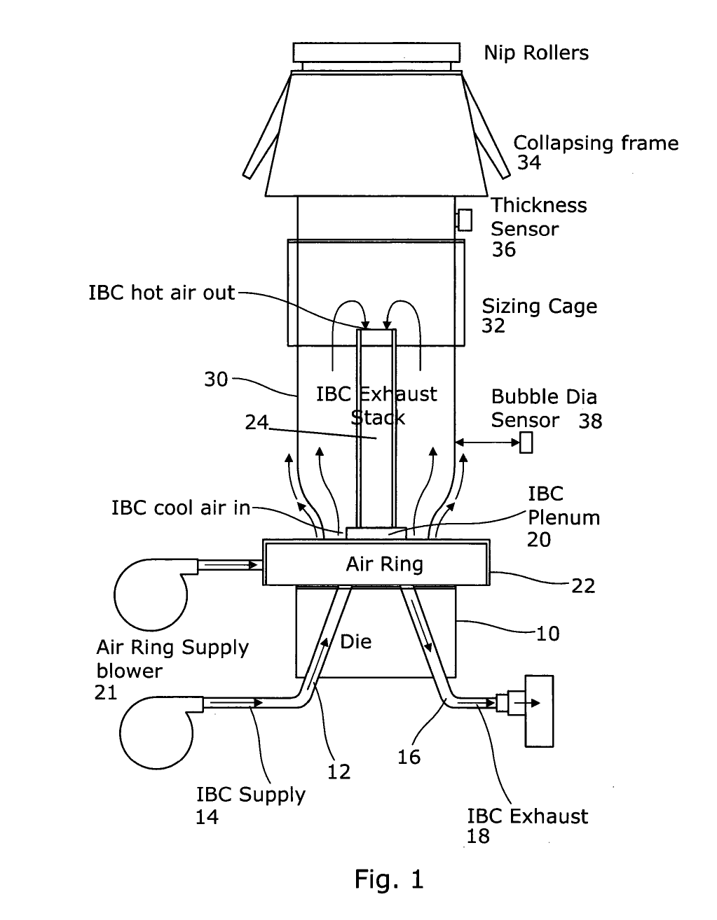

FIG. 1 is a schematic diagram of a blown extrusion system according to the prior art;

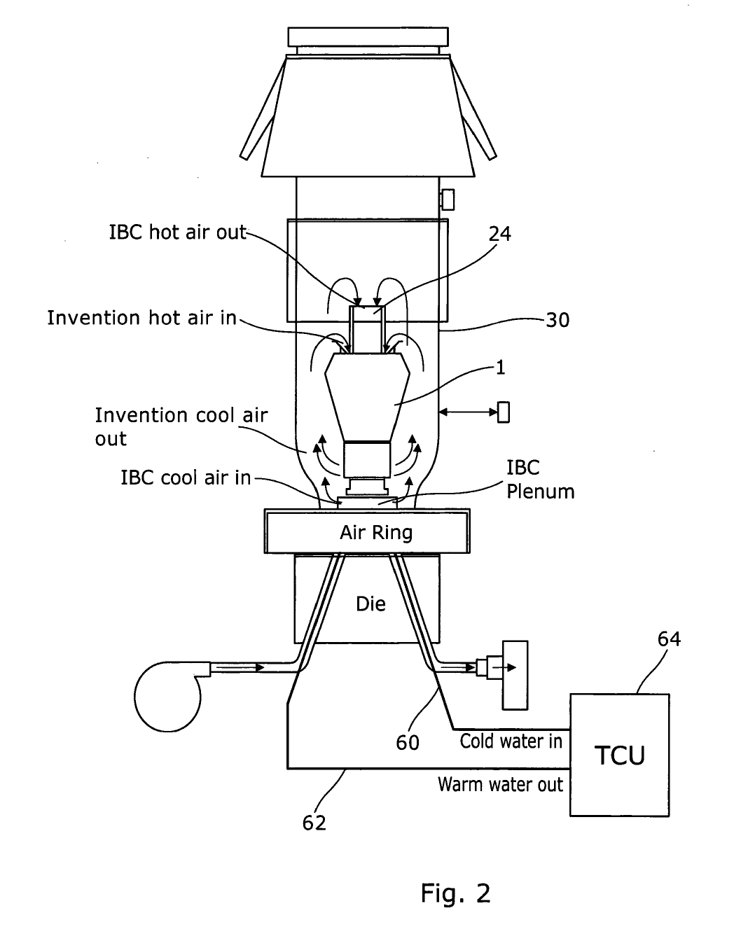

FIG. 2 is a schematic diagram of a blown extrusion system according to an exemplary embodiment of the present invention;

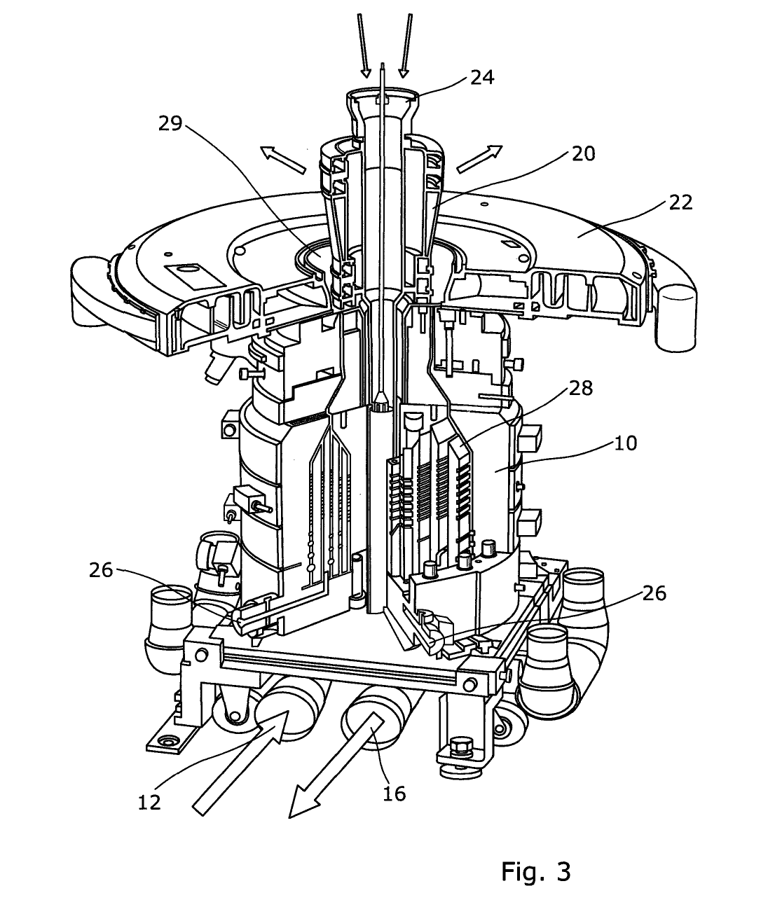

FIG. 3 is a cutaway perspective view of a circular die, air ring, IBC plenum and IBC exhaust stack portion for use in a system according to an exemplary embodiment of the present invention;

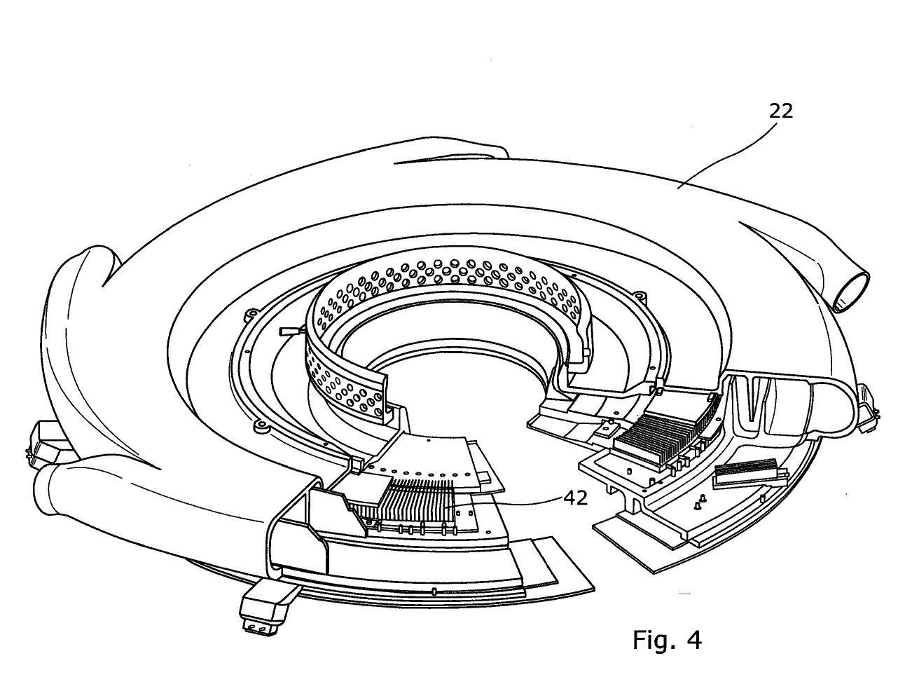

FIG. 4 is a perspective cutaway view of an air ring for use in a system according to an exemplary embodiment of the present invention;

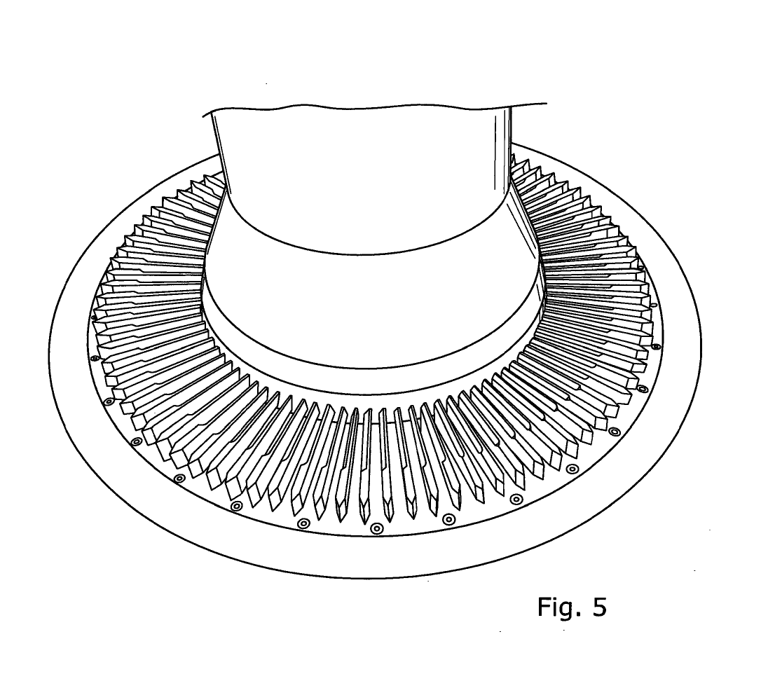

FIG. 5 is a perspective view of a lower radial air distributor for use in an exemplary embodiment of the present invention;

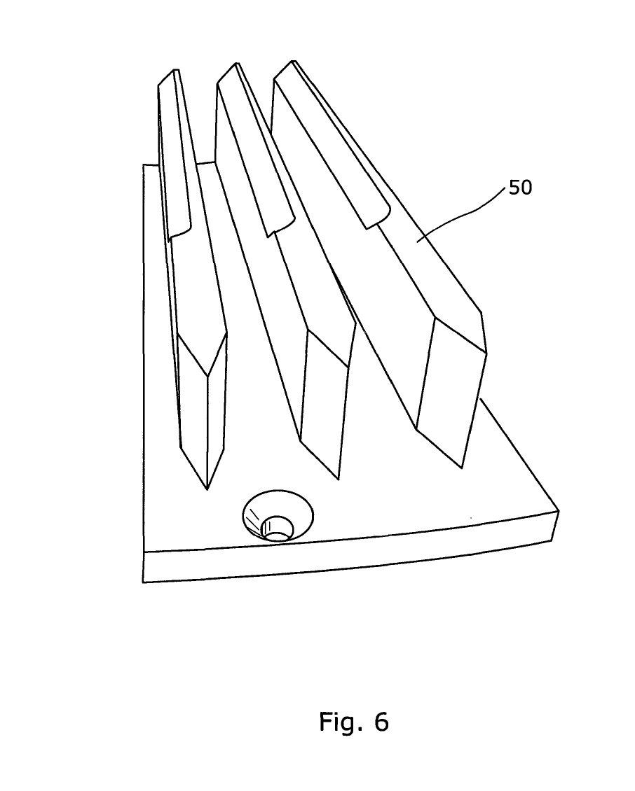

FIG. 6 is a perspective view of a heater element and radial vein segment for use in the lower radial air distributor of FIG. 5;

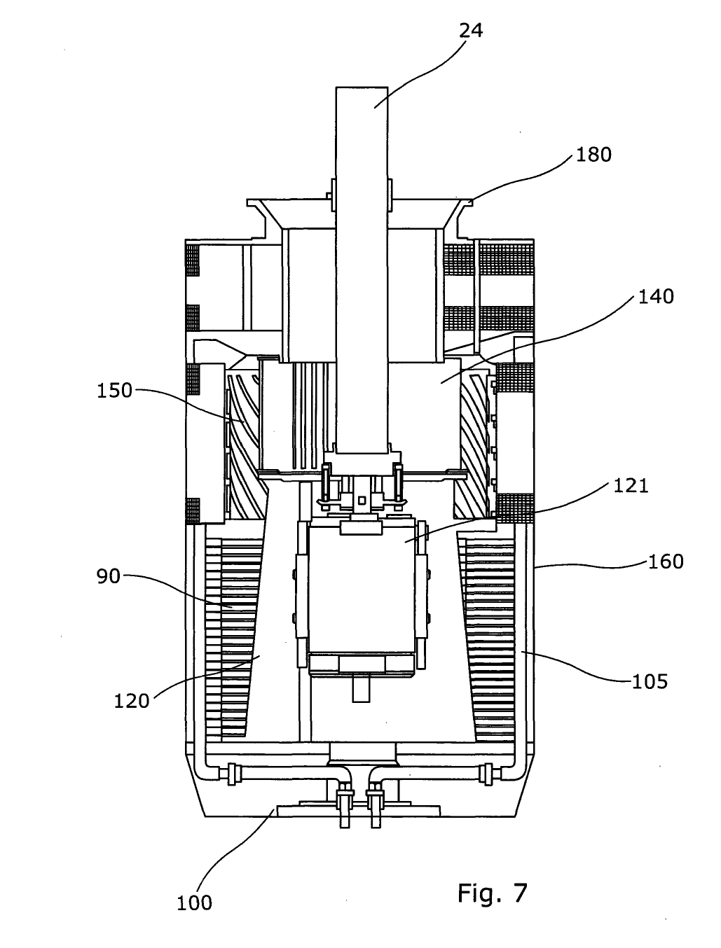

FIG. 7 is a schematic diagram of the cooling stack for use in a system according to an exemplary embodiment of the present invention; and

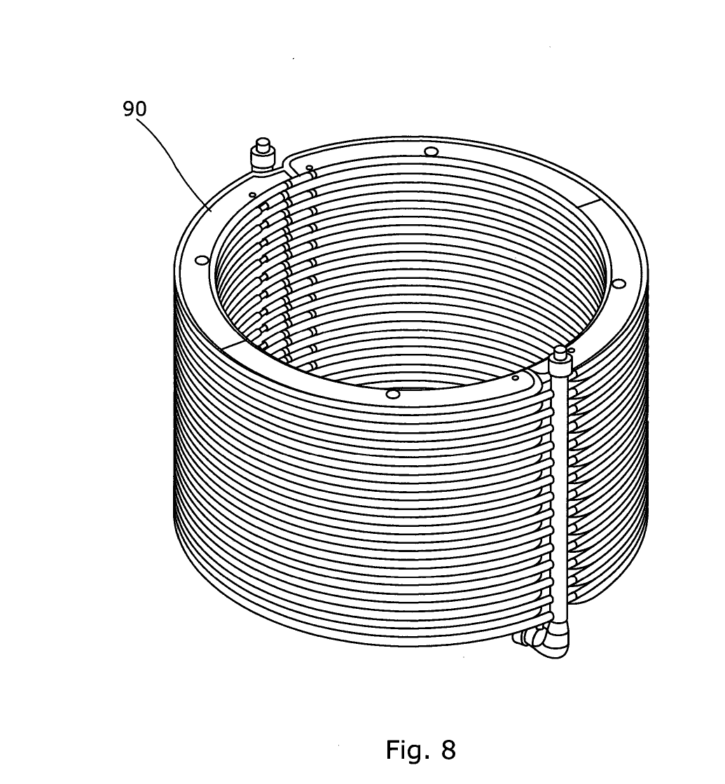

FIG. 8 is a perspective view of part of a heat exchanger for use in a system according to an exemplary embodiment of the present invention; and

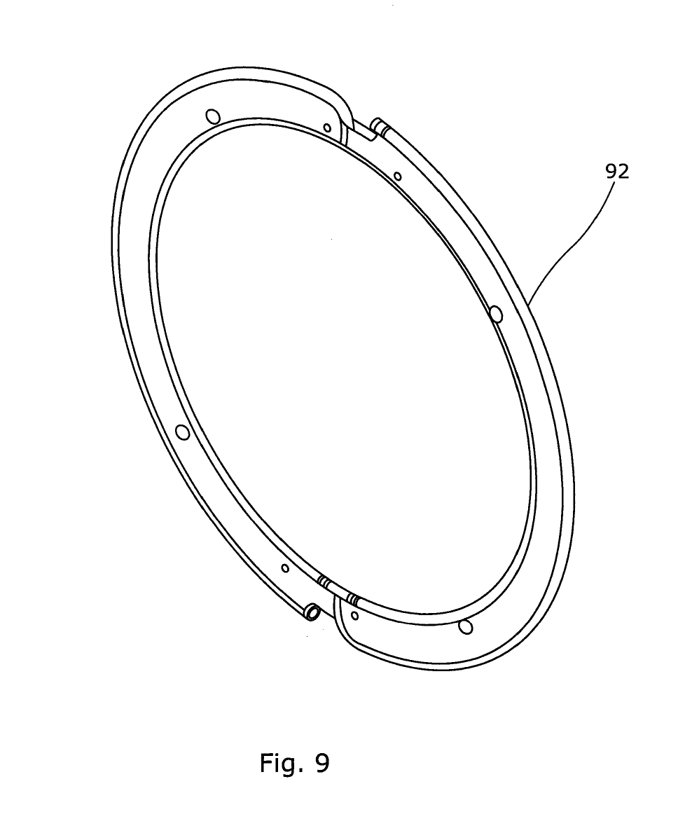

FIG. 9 is a perspective view of a cooling ring for use in the heat exchanger of FIG. 8.

Referring to FIG. 1 of the drawings, there is shown a schematic diagram of a blown extrusion system according to the prior art. The illustrated system comprises a circular die 10, having an air inlet pipe 12 and IBC plenum 20 for receiving an air supply 14. The IBC Exhaust stack 24 supplying an outlet pipe 16 for connection to an exhaust system 18. An air ring portion 22 supplied from an air ring blower 21 is provided on the circular die 10 to supply either ambient or chilled air to the outside of the bubble.

Referring additionally to FIG. 3 of the drawings, which shows a cutaway perspective view of the circular die 10, in use, a thermoplastic melt provided by an extruder is introduced into the circular die via an inlet 26 and fed through a spiral conduit 28 to form a tube which then exits the circular die via a concentric mandrel 29. The plastic tube is blown up with air from the pipe 12 “IBC Supply” and when the bubble reaches the correct diameter the IBC Exhaust pipe 16 removes access air. In the illustrated example, which is a three layer circular die, three different plastics are extruded together in a ‘sandwich’-like structure. However, several different types of circular die are known, for use in the manufacture of plastic films for one, two or more than three layers, and the present invention is not intended to be limited in this regard.

Referring back to FIG. 1 of the drawings, the molten tube, once it exits the circular die 10, is intensively cooled on both the inner and outer surfaces with air. This is done externally with the aid of an air cooling ring (22) and air ring blower (21) mounted on the die 10, this cooling ring can be height adjustable to a predetermined distance above the circular die 10 and the present invention is not intended to be limited in this regard.

At the upper end of the film bubble 30, the inflated film tube is continuously laid flat by suitable guide mechanisms 34 and drawn off by nip rollers. A thickness sensor 36 is provided between the sizing cage 32 and the guide mechanisms 34, and sensors 38 are also provided externally of the bubble 30, to measure the diameter of the bubble, these measurements being fed to an automatic film profile control system (not shown).

The present invention provides additional internal air cooling to the inside of the bubble adding to that generated from the “IBC” Internal Bubble Cooling systems commonly supplied today, to increase the cooling rate on the inside of the bubble 30.

Thus, referring additionally to FIG. 2 of the drawings, the present invention provides a cooling stack 1 in which the IBC exhaust stack is integrated. As in the prior art system, the IBC system draws either ambient or chilled air from its general surroundings which is blown via the air supply 14 and IBC plenum 20 into the bubble 30, and then the hot air is drawn into the IBC Exhaust stack 24 and then expelled via the IBC exhaust pipe 16 and IBC exhaust blower 18 into the general surroundings. This is an open loop system drawing cool air into the bubble in via a blower 14 and sucking the hot air out by a second blower 18, as illustrated by the arrows in FIGS. 1 and 3 of the drawings.

Referring additionally to FIG. 4 of the drawings, ambient or chilled air drawn from the general surroundings is blown onto the outside surface of the bubble via an air ring 22 at high pressure using the air ring supply blower 21. As the air rises up the bubble 30 it is dissipated into the general surroundings. Today, the air ring 22 is commonly used to control the thickness profile of the film, which is done by controlling the temperature of a plurality of radial fins or veins 42 using heated elements, wherein adjacent sets of veins define radial conduits through which the air is expelled. Thus, the arrangement of the air ring 22 and the air ring blower 21 represents an open loop system for supplying air to cool the outside of the bubble.

Referring to FIG. 7 of the drawings, there is shown a schematic diagram of the cooling stack 1 according to an exemplary embodiment of the present invention. The arrangement comprises a base plate 100 which acts as the mount to the modified IBC plenum and through which water pipes 105 enter the cooling system to feed a heat exchanger arrangement, the IBC exhaust gases pass through and electrical cabling. The heat exchanger arrangement comprises a pair of upright pipes 105 for flow and return of the cooling water to a set of concentric copper rings 92 (one of which is illustrated in FIG. 9) mounted in a cylindrical frame 90 surrounding a central shaft air baffle 120 which has, at its upper end a compartment 121 housing a motor, and a fan assembly 140. The copper rings define a substantially cylindrical chamber, as can be seen more clearly in FIG. 8 of the drawings, the height and diameter of which chamber controls the effective size of the heat exchanger. The copper rings 92 are assembled, alternately, left and right hand, to the water pipes 105 in the cylindrical chamber, to enable reverse direction cooling water flow between each coil, to achieve a more even radial distribution of air temperature through the coils. Each coil includes thin copper plates, on top and bottom faces, to increase surface area and improve heat recovery efficiency. In addition, these copper plates act as extended land areas to help maintain air pressure inside the invention and also stabilise the air flow radially through the heat exchanger A cylindrical air distributor, with spiral vanes, 150 extends upwardly from the heat exchanger arrangement and surrounds the motor compartment 121 and the fan assembly 140. The air distributor 150 supports an air inlet manifold 180 through which warm air is drawn, by the fan assembly 140, into the air distributor 150. The fan assembly 140 is a centrifugal fan configured to speed the incoming air up to very high velocities such that when it is fed into the air distributor 150 which acts as a cyclone. The air is thus spun like a tornado down the air distributor 150. This air is fed into the heat exchanger arrangement, i.e. the chamber 90 defined by the copper rings 92 being fed with water. As the air is spun in this chamber, the air is forced onto the surface of each copper ring and heat from the air is transferred to the cooler rings. The effect of the circumferential forces maximises the turbulence of the air against the surface. Furthermore, because the air passes over each ring multiple times as it is spun, the effective surface area of the heat exchanger is further increased. As stated, this results in heat transfer on the inner surface of each copper ring, and the copper coil plates, as air escapes between each ring.

Depending on process requirements, air flow spins within the chamber and exits:
1. at the bottom, via a plate, hereinafter referred to as a lower radial air distributor, on which is mounted a plurality of circumferential veins 50, as can be seen more clearly in FIG. 5 of the drawings. The remaining air which escapes between the rings, which improves the efficiency of the heat exchanger, is then collected in an outer tube and dispersed back into the main air stream at the bottom of the machine.
2. through a cylindrical mesh outer screen 160, with defined profile, to allow air to be uniformally expelled radially from the voids between the cooling coils.
3. a combination of 1. and 2. above, depending on processing requirements. Because the heat exchanger is water cooled, the efficiency of the system can be managed by varying the flow rate of the water, the temperature of the water into the heat exchanger and the temperature of the water out of the heat exchanger:

Flow rate*(temperature out−temperature in)*coefficient=Cooling rate

Thus, the rate of cooling can be controlled by either changing the temperature of the cooling water or changing the flow rate of the air by running the fan faster or slower. Both of these will have different effects on the process.

A heating element associated with the plurality of veins 50 on the lower radial air distributor plurality of fins or veins (as illustrated in FIG. 6 of the drawings) may be provided within the cooling stack 1 for selectively heating the expelled air out of the present invention prior to its introduction into the space defined by the bubble 30, according to control signals received from the automatic film profile control system (not shown) in response to measurements received from the sensors 38.

The embodiments described above are provided by way of examples only, and various other modifications will be apparent to persons skilled in the field without departing from the scope of the invention as defined by the appended claims.

1. A blown film extrusion system, comprising:
a cooling stack comprised of an integrated IBC Exhaust, an air inlet manifold, a fan assembly and a substantially cylindrical air distributor for receiving a flow of air from said air inlet, said air distributor having spiral vanes and defining an air flow conduit and direction of said air flow, the cooling stack further comprising a substantially cylindrical heat exchanger for receiving said air flow from said air distributor; and
means for additional cooling on the inside of the bubble as the tube of molten plastic transitions into a bubble around said cooling stack;
the cooling stack being configured to draw air from within said bubble into said heat exchanger via said air distributor, and means for expelling air from said heat exchanger back into the space defined between said bubble and said cooling stack.

2. A system according to claim 1, wherein said air distributor includes an air outlet including a plate carrying a plurality of radial veins defining radial conduits for guiding air from the heat exchanger into the space defined between said bubble and said cooling means.

3. A system according to claim 1, wherein said cooling stack includes a substantially cylindrical mesh outer screen, with defined profile, for allowing air to be uniformly expelled substantially radially from one or more voids within said heat exchanger.

4. (canceled)

5. (canceled)

6. A blown film extrusion system, comprising:
cooling means comprised of an air inlet manifold, a heat exchanger and an air outlet; means for cooling a tube of molten plastic into a bubble around said cooling means; the cooling means being configured to draw air from within said bubble onto said heat exchanger and to said air outlet, wherein said system includes a substantially cylindrical mesh outer screen, with defined profile, for allowing air to be uniformly expelled substantially radially from one or more voids within said heat exchanger.

7. A cooling system adapted to be mounted within a blown film extrusion system comprised of an integrated IBC exhaust, an air inlet manifold and means for cooling a tube of molten plastic into a bubble around said cooling system, the cooling system comprising a fan assembly, a substantially cylindrical air distributor, with spiral vanes, defining an air flow conduit and direction of the air flow and a substantially cylindrical heat exchanger for receiving said air flow from said air distributor, the cooling being configured to draw air into said heat exchanger via said air distributor, and means for expelling air from said heat exchanger after cooling.

8. A system according to claim 2, wherein the veins are equidistantly spaced substantially all of the way around the circumference of the plate, such that air is uniformly expelled all of the way around the base of the bubble.

9. A system according to claim 2, further comprising a heating means for selectively heating said veins so as to heat air as it is expelled into the space defined between said bubble and said cooling means.

10. A system according to claim 1, wherein the heat exchanger comprises a plurality of concentric tubes so as to form a substantially cylindrical chamber, and the system further comprises one or more pipes for feeding water into said tubes.

11. A system according to claim 10, wherein the concentric tubes are alternately arranged relative to said one or more pipes, so as to alternately reverse water flow direction therethrough.

12. A system according to claim 1, further comprising one or more sensors for measuring the thickness of the blown film.

13. A system according to claim 12, further comprising a film profile control system for receiving measurements from said one or more sensors.

14. A system according to claim 13, wherein said film profile control system comprises means for varying one or more process parameters in order to control the film thickness profile.

15. A system according to claim 14, wherein said process parameters include water flow rate and temperature into the heat exchanger and rate of flow of air into the heat exchanger.

16. A system according to claim 13, when dependent on claim 9, wherein said film thickness profile is controlled by means of said heating means.

17. (canceled)

18. (canceled)

19. (canceled)
